(19) United States
(12) Patent Application Publication
(10) Pub. No.: US 2013/0251209 A1
(43) Pub. Date: Sep. 26, 2013

(54) IMAGE PROCESSING APPARATUS AND METHOD FOR VEHICLE

(71) Applicant: CORE LOGIC INC., Seoul (KR)

(72) Inventor: Byungho KIM, Suwon-si (KR)

(73) Assignee: CORE LOGIC INC., Seoul (KR)

(21) Appl. No.: 13/847,896

(22) Filed: Mar. 20, 2013

(30) Foreign Application Priority Data
Mar. 21, 2012 (KR) 10-2012-0028932

(51) Int. Cl. G06K 9/00

(52) U.S. Cl. CPC G06K 9/00791
USPC 382/106

(57) ABSTRACT

Embodiments of the invention relate to an image processing apparatus and method of a black box system for vehicles, which can simplify an analysis stage without causing any Doppler effect by directly analyzing an image of a camera basically mounted to the black box for vehicles, and which includes a unit for detecting an accident risk before a sudden braking operation and occurrence of an accident. The image processing apparatus includes: a subject distance change detector which analyzes a size change of a subject present in an image captured by a camera to detect a distance change between the camera and the subject; a light source analyzer which analyzes a light source present in the image; an image divider which divides the image into plural sections to apply a differently weighted accident-risk level value to each of the divided sections; and an alarm unit for generating an alarm corresponding to an accident-risk situation in the divided sections.

### CROSS-REFERENCE TO RELATED APPLICATION

This application claims priority to Korean Patent Application No. 10-2012-0028932 filed on 21 Mar. 2012, and all the benefits accruing therefrom under 35 U.S.C. §119, the contents of which is incorporated by reference in its entirety.

### BACKGROUND

1. Technical Field

The present invention relates to an image processing apparatus and method for vehicles, and more particularly, to an image processing apparatus and method of a black box system for vehicles, which can alert a driver of a high accident-risk situation, recognize a surrounding situation by analyzing captured images to permit separate management of an image corresponding to a high accident-risk situation, and determine an accident-risk level in advance, thereby preventing an accident.

2. Description of the Related Art

As generally known in the art, a black box for vehicles photographs an accident situation using small cameras disposed on front and rear windshields of the vehicle, and collects and stores audio data collected by a microphone in a storage medium, for example, a memory card. The black box normally records situations relating to driving of the vehicle for durations secured by the storage medium. The black box is operated as soon as the vehicle is started, and in the case of an accident, that is, if impact is applied to the vehicle, driver's voice, impact sounds, operating situations of an accelerator, a vehicle speed, a time point, and the like are recorded in the storage medium in detail.

FIG. 1 is a block diagram of a black box system for vehicles in the related art.

Referring to FIG. 1, the black box system includes sensors 14, 16 for detecting a vehicle speed, external impact, and the like, a front camera 11 for photographing a forward side of the vehicle, a rear camera 12 for photographing a rearward side of the vehicle, and a black box 18 which stores vehicle driving information.

The black box 18 includes video encoder 20, video sensor 22 and video decoder 24 which control input and output of video signals by the front and rear cameras 11, 12 and decode or encode the input and output video signals; a microcomputer 28 which controls overall operation of the black box 18; a drive data memory 30 which stores driving situations captured by the front and rear cameras as video signals for a predetermined period of time set based on a current time by a timer 34; and a video memory 26 which decompresses current video signals recorded in a compressed state in the drive data memory 30 and stores the decompressed video signals.

Further, the black box 18 includes a display unit 44 for displaying video signals stored in the drive data memory 30 and the video memory 26, and an input interface unit 32 for inputting signals of the speed sensor 14 and the impact sensor 16, the vehicle mechanism input signal and the key detection signal to the microcomputer 28.

Normally, the drive data memory 30 repeatedly performs an operation of storing and removing driving conditions of the vehicle at predetermined intervals, and stores a driving condition before and after an accident according to a signal from an impact sensor when the accident occurs.

The black box system in the related art may employ a technology of measuring a distance between a preceding vehicle and a following vehicle and speed, for example, using a radar sensor, or employ a technology of detecting sudden stop and an accident using acceleration sensors (for example, X, Y, and Z-axis acceleration sensors), allowing for more accurate accident analysis.

Technology employing a radar sensor is disclosed in Korean Patent Publication No. 10-2009-0070073A entitled “Black Box for Vehicle and Method of Controlling the same” and technology employing an acceleration sensor is disclosed in Korean Patent Publication No. 10-2006-0043342A entitled “Black Box for Vehicle”.

However, when a radar sensor is used in the black box system in the related art, the radar sensor must be mounted separately from a black box for vehicles and a relatively slow radar signal is used, necessitating a Doppler effect calibration step. Further, when an acceleration sensor is used, an accident-risk is detected after a sudden change (an accident and a sudden braking operation) occurs upon driving of the vehicle.

### BRIEF SUMMARY

An aspect of the present invention is to provide an image processing apparatus and method of a black box system for vehicles, which can simplify an analysis stage without causing any Doppler effect by directly analyzing an image of a camera basically mounted to the black box for vehicles, and which includes a unit for detecting danger before a sudden braking operation and occurrence of an accident.

That is, the present invention is directed to the provision of an image processing apparatus including: a unit for analyzing a size change of a subject to determine a distance change between the camera and the subject, a unit for analyzing a color of a light source in an image to determine an accident-risk level, analyzing a contrast difference between the subject and a background image to determine an accident-risk level, and dividing an image into sections to apply a differently weighted accident-risk level value to each of the divided sections, and a unit for analyzing symbols and characters using the divided sections.

In accordance with one aspect of the invention, an image processing apparatus for vehicles includes: a subject distance change detector which analyzes a size change of a subject present in an image captured by a camera to detect a distance change between the camera and the subject; a light source analyzer which analyzes a light source present in the image; an image divider which divides the image into plural sections to apply a differently weighted accident-risk level value to each of the divided sections; and an alarm unit for generating an alarm corresponding to an accident-risk situation in the divided sections.

The light source analyzer may analyze a contrast and a color of a background image.

The image divider may set the divided sections using at least one trapezoidal shape.

The light source analyzer may detect activation of a red traffic light and activation of brake lamps and direction lamps of surrounding vehicles.

The light source analyzer may detect brightness of a headlamp of the vehicle reflected by a front object, brightness of upper and rear lamps of a preceding vehicle, and brightness of a headlamp of a vehicle approaching from a front side.

In accordance with another aspect of the invention, an image processing method for vehicles includes: analyzing a size change of a subject present in an image captured by a camera to detect a distance change between the camera and the subject; analyzing a light source present in the image; and dividing the image into one or more trapezoidal sections to determine an accident-risk level based on a differently weighted accident-risk level value applied to each of the divided sections and a distance change between the analyzed light source and the subject; and generating an alarm corresponding to the accident-risk level.

The analyzing a light source may include analyzing a contrast and a color of a background image; detecting activation of a red traffic light, activation of brake lamps of surrounding vehicles, and activation of direction lamps of surrounding vehicles; and detecting brightness of a headlamp of the vehicle reflected by a front object, brightness of upper and rear lamps of a preceding vehicle, and brightness of a headlamp of a vehicle approaching from a front side.

According to the present invention, the apparatus and method can recognize a surrounding situation by analyzing images to permit separate management of an image of a high accident-risk situation, and can determine an accident-risk level in advance, thereby preventing an accident.

### BRIEF DESCRIPTION OF THE DRAWINGS

The above and other aspects, features, and advantages of the invention will become apparent from the detailed description of the following embodiments in conjunction with the accompanying drawings, in which:

FIG. 1 is a diagram of a black box system in the related art;

FIG. 2 is a block diagram of an image processing apparatus of a black box system for vehicles according to one embodiment of the present invention;

FIG. 3 is a flowchart of an image processing method of a black box system for vehicles according to one embodiment of the present invention; and

FIGS. 4 to 7 are views of exemplary embodiments of the image processing apparatus and method of a black box system for vehicles according to the present invention.

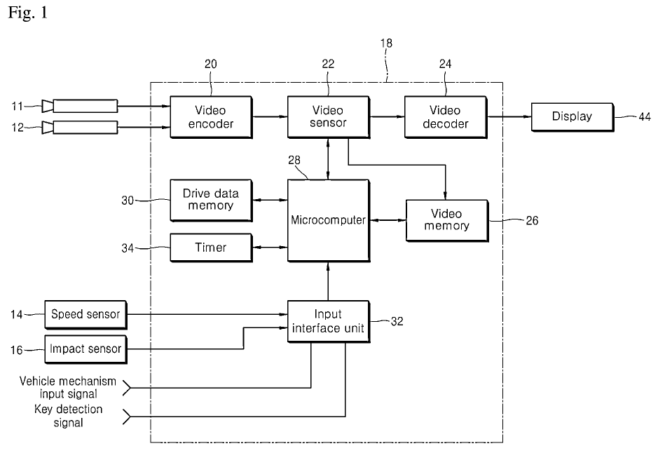

### DETAILED DESCRIPTION

Embodiments of the present invention will now be described in detail with reference to the accompanying drawings. It should be understood that the present invention is not limited to the following embodiments and may be embodied in different ways, and that the embodiments are given to provide complete disclosure of the invention and to provide thorough understanding of the invention to those skilled in the art. Descriptions of details apparent to those skilled in the art will be omitted for clarity.

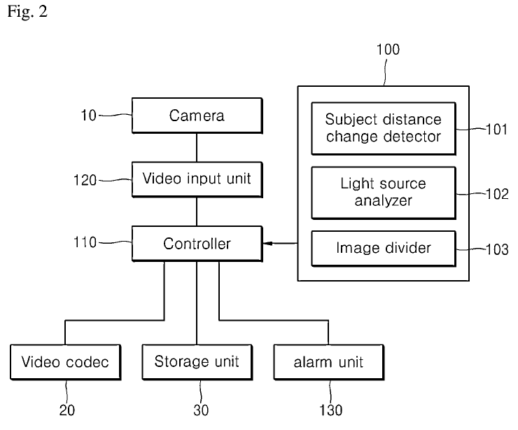

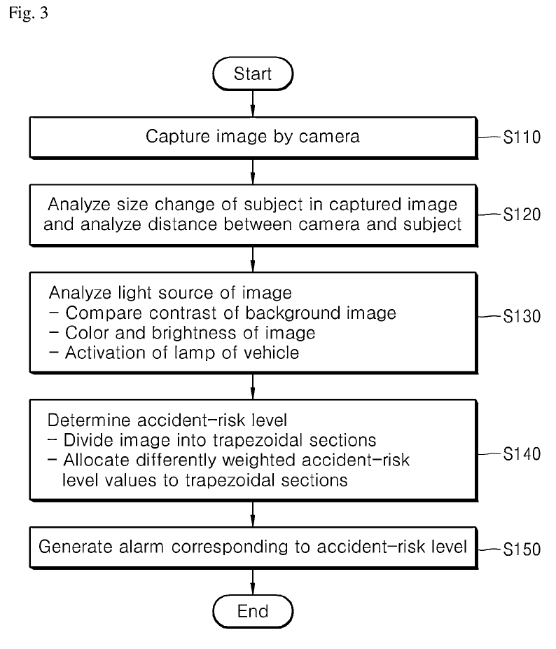

FIG. 2 is a block diagram of an image processing apparatus of a black box system for vehicles according to one embodiment of the present invention, and FIG. 3 is a flowchart of an image processing method of a black box system for vehicles according to one embodiment of the present invention.

Referring to FIG. 2, an image processing apparatus for vehicles according to one embodiment includes a camera 10 which photographs a driving situation of the vehicle, a video input unit 120 which receives an image captured by the camera 10, a controller 110 which controls the black box system, a video codec 20 which encodes/decodes the image captured by the camera 10 under control of the controller 110, a storage unit 30 which stores video data under the control of the controller 110, an image analyzer 100 which analyzes the captured image under control of the controller 110, and an alarm unit 130 which generates information corresponding to an accident-risk situation analyzed by the image analyzer 100.

The image analyzer 100 may include a subject distance change detector 101 which analyzes a size change of a subject present in an image captured by the camera 10 to detect a distance change between the camera and the subject, a light source analyzer 102 which analyzes a light source present in the image, and an image divider 103 which divides the image into plural divided sections and applies a differently weighted accident-risk level value to each of the divided sections.

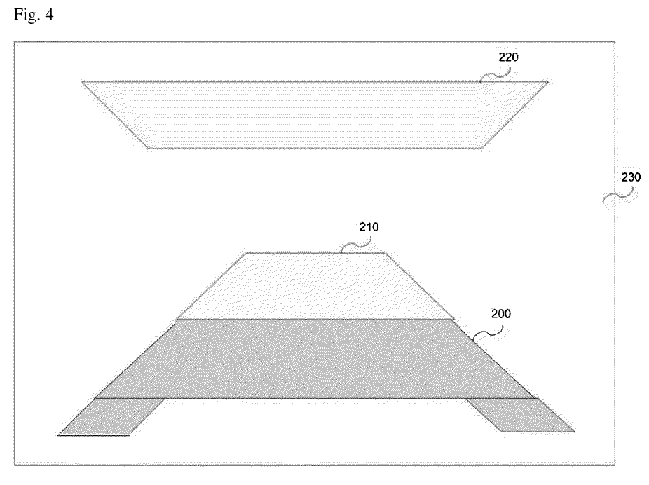

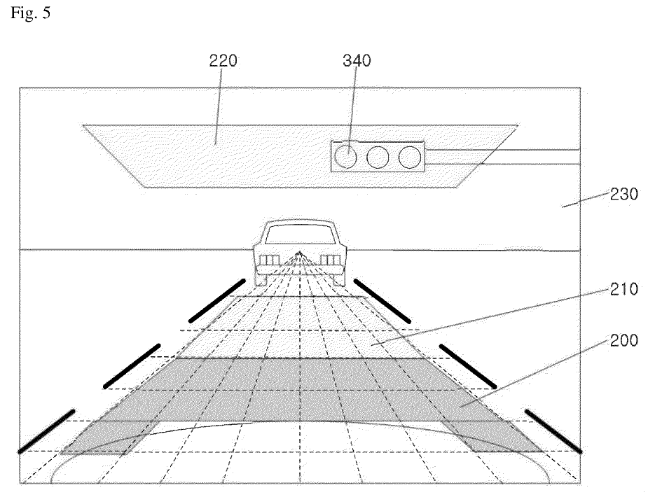

As shown in FIGS. 4 and 5, the image divider 103 may set the divided sections using one or more trapezoids.

For example, the image divider 103 may set two or more divided sections in a direction in which the vehicle runs. Further, the divided sections may be set in an upward direction of the vehicle by taking a location of a traffic light into account.

Further, the image divider 103 may apply differently weighted accident-risk level values to the divided sections, respectively. Considering design, the weighted accident-risk level values may be set to be large at a site of higher danger, and may be set to be small at a site of lower danger.

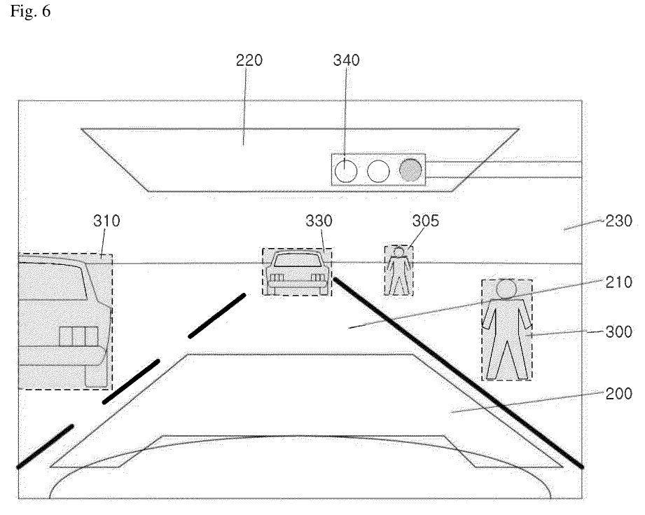

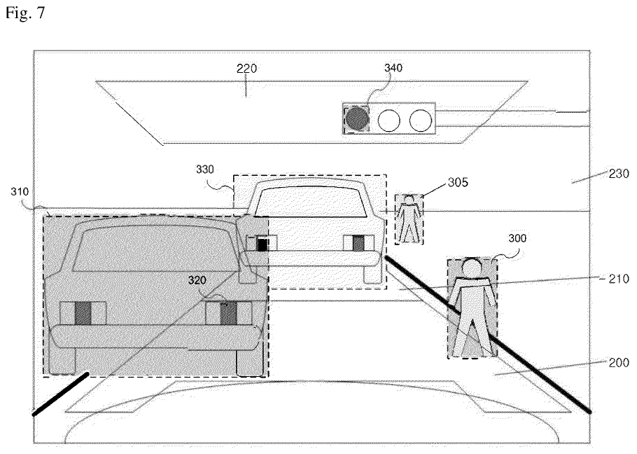

The subject distance change detector 101 analyzes a size change of a subject present in the image to detect a distance change between the camera and the subject. A correlation between the distance change between the camera 10 and the subject and the size change of the image may be set in inverse proportion to the square root of the distance change by the subject distance change detector 101. As shown in FIGS. 6 and 7, the light source analyzer 102 analyzes contrast of a background of an image and a color of the image, detects activation of a red traffic lamp and activation of brake lamps and direction lamps of surrounding vehicles, and detects brightness of a headlamp of the vehicle reflected by a front object, brightness of upper and rear lamps of a preceding vehicle, and brightness of a headlamp of a vehicle approaching from a front side.

Now, operation of the image processing apparatus for vehicles according to the embodiment will be described with reference to FIGS. 2 to 7.

First, an image (video) is captured by the camera 10 of the image processing apparatus. The acquired image is input through the video input unit 110. The input image is encoded and decoded through the video codec 20 and stored in the storage unit 30.

The vehicle driving image captured by the camera 10 is input through the video input unit 110 (S110), and the image analyzer 100 and the controller 110 match the image with divided sections set by the image divider 103.

Next, the subject distance change detector 101 of the image analyzer 100 may analyze a size change of the subject present in the image under control of the controller 110 to detect a distance change between the camera and the subject (S120).

The correlation between the distance change between the camera 10 and the subject and the size change of the image may be set in inverse proportion to the square root of the distance change by the subject distance change detector 101.

The light source analyzer 102 analyzes a light source in the image (S130). The light source analyzer 102 identifies and analyzes, for example, contrast of a background image, a color and brightness of an image, and activation of lamps of the vehicle.

The light source analyzer 102 may include a cadmium sulfide (CdS) optical sensor, an illumination sensor, a photo sensor, or a light detecting sensor.

The subject distance change detector 101 and the lamp analyzer 102 may be operated in parallel. In other words, the light source analyzer 102 may be operated to analyze a light source in the image while the subject distance change detector 101 is operated. That is, the light source analyzer 102 may be operated substantially together with the subject distance change detector 101.

The controller 110 controls the image divider 103 to allow the image divider 103 to match data analyzed by the light source analyzer 102 with one or more predetermined divided trapezoidal sections to determine a risk level (S140).

The one or more divided trapezoidal sections are stored in the image divider 103. Differently weighted accident-risk level values are applied to the trapezoidal sections stored in the image divider 103, respectively. That is, as shown in FIG. 4, the differently weighted accident-risk level values are applied to the divided sections in the image to increase utility of the image analysis result. The weighted accident-risk values may be stored in the image divider 103 for use.

As a result, the controller 110 may receive signals from the subject distance change detector 101, the light source analyzer 102 and the image divider 103, and may determine an accident-risk situation and an accident-risk level based on the divided trapezoidal sections, the weighted risk level value of each trapezoidal section, and the distance change between the analyzed light source and the subject (S140).

In another embodiment, determination as to the accident-risk level may be performed not by the controller 110, but by the subject distance change detector 101, the light source analyzer 102, and/or the image divider 130, and then the determination result may be input to the controller 110.

The alarm unit 130 generates an alarm to a driver according to the accident-risk determination result whereby the driver can prevent an accident in advance (S150). The alarm unit 130 is controlled by the controller 110.

FIGS. 4 to 7 show exemplary embodiments for the image processing apparatus and method for vehicles according to the present invention.

Next, a method of determining an accident-risk level using the image processing apparatus according to one embodiment of the invention will be described with reference to FIGS. 2 to 7.

In FIG. 4, a divided section denoted by 200 is an accident-risk section which has a very high accident-risk weight value. A divided section denoted by 210 is a boundary section which has a high accident-risk weight value. A divided section denoted by 220 is a traffic signal detection section corresponding to a light source color analysis section. A divided section denoted by 230 corresponds to other sections having low accident-risk weight values.

The weight value may be set, for example, to 0.5 for the section 200, 0.2 for the section 210, 0.2 for the section 220, and 0.1 for the section 230. FIG. 5 is a view in which an image captured by the camera overlaps the divided sections shown in FIG. 4.

The subject distance change detector 101 may compare two or more images to analyze a change rate of the size of the subject. For example, the subject distance change detector 10 may compare a previous image captured by the camera with the current image to analyze the size change rate of the subject.

The subject distance change detector 101 may analyze the size change rate using Equation 1.

Δl∝1/\sqrt{d−Δd} <Equation 1>

Here, Δl is a size change rate of a subject according to a distance change between the subject and the camera 10, d is a distance between the subject and the camera, and Δd is a distance change between the subject and the camera.

In Equation 1, a change in length of the transverse or longitudinal axis of the subject is inversely proportional to the square root of the distance between the subject and the camera 10.

Thus, a great size change of the subject means that the subject is close to the vehicle provided with the camera 10, or the distance between the subject and the vehicle provided with the camera 10 is rapidly decreasing.

That is, the image analyzer 100 determines that an accident-risk level between the subject and the vehicle provided with the camera 10 increases with increasing size of the subject.

The accident-risk situation determined by the image analyzer 100 is input to the controller 100, which in turn controls the alarm unit 130 to generate a corresponding alarm based on the input accident-risk situation.

Referring to FIGS. 2, 6, and 7, the light source analyzer 102 may analyze a contrast of a background image captured by the camera 10 and a color of the image. FIG. 6 shows a safe state and FIG. 7 shows a dangerous state.

The light source analyzer 102 analyzes the contrast of the subject 300, 305, 310, 330, 340 under control of the controller 110 to determine an accident-risk level.

As shown in FIGS. 6 and 7, the light source analyzer 102 analyzes brightness of a headlamp of the vehicle reflected by front objects 300, 305, 310, 330, brightness of upper and rear alarm lamps of preceding vehicles 310, 330, and brightness of a headlamp of a vehicle approaching from the front side. In the present invention, the light source analyzer 102 determines that red/yellow position lamps having low illumination are not dangerous.

The image analyzer 100 combines information of the light source analyzer 102 and information of the image divider 103 to analyze an accident-risk level, which will be described below in detail.

Referring to FIG. 7, when a subject 300 is captured within an accident-risk section 200 (FIG. 4) by the camera, and/or when a change rate of size of the subject 310 is large in the accident-risk section 200, the image analyzer 100 determines that the vehicle is in a very high accident-risk situation.

Further, when the subject is present in the boundary section 210 (FIG. 4), the image analyzer 100 determines that the vehicle is in an accident-risk situation if the size change rate of the subject is large, and/or the image analyzer 100 determines that the vehicle is in a low accident-risk situation if the size change rate of the subject is small.

Meanwhile, in relation to the accident-risk level according to a color of the light source, if a new red lamp 320 is found within the accident-risk section 200, the image analyzer 100 determines a high accident-risk situation (ALL), and/or if a red lamp 340 is found in the traffic signal detection section 220 (FIG. 4) and the size change rate of the red light source is large, the image analyzer 100 determines that the vehicle is in a high accident-risk situation, and/or if the size change rate of the red light source is 0 or very small, the image analyzer 100 determines that the vehicle is in a low accident-risk situation.

It is apparent that the driving information storage method of the black box system may be performed through an automated procedure according to a time-based sequence by a software program installed in storage media. Code and code segments of the program may be easily deduced by a computer programmer in the art. In addition, the program is stored in computer readable media and is read and executed by a computer to implement the driving information storage method. The storage media may include magnetic recording media, optical recording media, and carrier wave media.

Although some embodiments have been described herein, it should be understood by those skilled in the art that these embodiments are given by way of illustration only, and that various modifications, variations, and alterations can be made without departing from the spirit and scope of the invention. Therefore, the scope of the invention should be limited only by the accompanying claims and equivalents thereof.

What is claimed is:

1. An image processing apparatus for vehicles, comprising:
an image divider which stores predetermined divided sections to which differently weighted accident-risk level values are applied;
a subject distance change detector which analyzes a size change of a subject present in an image captured by a camera to detect a distance change between the camera and the subject;
a light source analyzer which analyzes a light source present in the image; and
a controller which determines an accident-risk situation in the predetermined divided sections based on signals from the subject distance change detector, the light source analyzer, and the image divider.

2. The image processing apparatus according to claim 1, further comprising an alarm unit for generating an alarm according to an accident-risk determination result.

3. The image processing apparatus according to claim 1, wherein the light source analyzer analyzes a contrast of a background image.

4. The image processing apparatus according to claim 1, wherein the light source analyzer analyzes a color of the background image.

5. The image processing apparatus according to claim 1, wherein the image divider sets and stores one or more trapezoidal divided sections.

6. The image processing apparatus according to claim 1, wherein the light source analyzer detects activation of a red traffic light, activation of brake lamps of surrounding vehicles, and activation of direction lamps of surrounding vehicles.

7. The image processing apparatus according to claim 1, wherein the light source analyzer detects brightness of a headlamp of the vehicle reflected by a front object, brightness of upper and rear lamps of a preceding vehicle, and brightness of a headlamp of a vehicle approaching from a front side.

8. An image processing method for vehicles, comprising:
analyzing a size change of a subject present in an image captured by a camera to detect a distance change between the camera and the subject;
analyzing a light source present in the image; and
matching the image with a predetermined trapezoidal divided section to determine, based on a weighted accident-risk level value applied to the divided section and a distance change between the analyzed light source and the subject, whether the subject in the image is in an accident-risk situation.

9. The image processing method according to claim 8, further comprising generating an alarm according to the accident-risk situation.

10. The image processing method according to claim 8, wherein the analyzing a light source comprises analyzing a contrast and a color of a background image.

11. The image processing method according to claim 8, wherein the analyzing a light source comprises detecting activation of a red traffic light, activation of brake lamps of surrounding vehicles, and activation of direction lamps of surrounding vehicles.

12. The image processing method according to claim 8, wherein the analyzing a light source comprises detecting brightness of a headlamp of the vehicle reflected by a front object, brightness of upper and rear lamps of a preceding vehicle, and brightness of a headlamp of a vehicle approaching from a front side.
